(19) United States
(12) Patent Application Publication
(10) Pub. No.: US 2026/0065399 A1
(43) Pub. Date: Mar. 5, 2026

(54) Academic Intervention System

(71) Applicant: Oracle International Corporation, Redwood Shores, CA (US)

(72) Inventors: Nicole Engelbert, Tuckahoe, NY (US); James Thomas Mckendree, Elizabeth, CO (US); Mayuko Ueda, San Leandro, CA (US)

(73) Assignee: Oracle International Corporation, Redwood Shores, CA (US)

(21) Appl. No.: 19/186,197

(22) Filed: Apr. 22, 2025

Related U.S. Application Data
(60) Provisional application No. 63/690,652, filed on Sep. 4, 2024.

(51) Int. Cl. G06Q 50/20; G06N 20/00

(52) U.S. Cl. CPC G06Q 50/205; G06N 20/00

(57) ABSTRACT

Computer-based academic intervention techniques are disclosed. A system monitors an application programming interface (API) of a computer system. While monitoring the API during a current academic period, the system detects a change in non-academic data exposed by the API. Responsive to detecting the change in the non-academic data, the system identifies a subset of the non-academic data that is associated with a particular student, and applies a machine-learning model to the subset of non-academic data to obtain a predicted likelihood of the particular student making satisfactory academic progress (SAP) at an academic institution where the particular student is enrolled. Responsive to determining that the predicted likelihood of the particular student making SAP at the academic institution does not satisfy a threshold criterion, the system presents a warning in a graphical user interface that the particular student is at risk of not making SAP.

### INCORPORATION BY REFERENCE; DISCLAIMER

This application claims the benefit of U.S. Provisional Patent Application No. 63/690,652, filed Sep. 4, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to computer-based academic intervention systems. In particular, the present disclosure relates to improving performance of a computer-based academic intervention system.

### BACKGROUND

Students at an academic institution may exhibit varying levels of academic performance. Academic progress of a particular student may depend on numerous factors. Some students make satisfactory academic progress (SAP), while other students do not make SAP. In some cases, SAP refers to the academic performance standards a student must meet to remain eligible for federal financial aid, a private scholarship, and/or other sources of academic funding that are contingent on meeting certain academic standards. For example, the standards may include making progress toward completing a degree within a certain amount of time and/or maintaining a minimum academic performance. Additionally or alternatively, SAP may refer to the academic performance standards required by the academic institution to award the degree. Additionally or alternatively, SAP may refer to the academic performance standards a student must meet (or is predicted to need to meet) for a particular path of post-graduate employment and/or post-graduate education. In general, SAP may refer to any kind of academic performance standard that the student must meet to achieve a predetermined objective.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 is a block diagram illustrating one embodiment of a computer system suitable for implementing methods and features described herein.

FIG. 2 illustrates an example set of operations for monitoring a predicted likelihood of a particular student making SAP.

FIGS. 3A and 3B are block diagrams that illustrate an example implementation of methods and features described herein.

FIG. 4 illustrates features of an example machine-learning system in accordance with one or more embodiments.

FIG. 5 is a flowchart that depicts example operations of a machine-learning system in accordance with one or more embodiments.

FIG. 6 is a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PRACTICAL APPLICATIONS
3. EXAMPLE SYSTEM ARCHITECTURE
4. EXAMPLE OPERATIONS
5. EXAMPLE EMBODIMENTS
6. EXAMPLE MACHINE-LEARNING SYSTEM
7. COMPUTER NETWORKS AND CLOUD NETWORKS
8. MICROSERVICE APPLICATIONS
9. HARDWARE OVERVIEW
10. MISCELLANEOUS; EXTENSIONS

### 1. GENERAL OVERVIEW

One or more embodiments train a machine-learning model to predict the likelihood of a student making SAP based on a combination of academic data and non-academic data. As used herein, the term “academic data” refers to data that describes historical academic results. The term “non-academic data” refers to data that does not describe any kind of academic results. Non-academic data may be related to an academic experience (e.g., dining hall data, housing data, etc.). Additionally, or alternatively, non-academic data may be unrelated to any academic experience (e.g., health records, social media, etc.). As discussed in further detail below, training the machine-learning model using non-academic data allows the machine learning model to predict a student's likelihood of making SAP even when current academic data (e.g., grades for a current academic period) is not available.

One or more embodiments determine, based at least in part on non-academic data pertaining to a student enrolled at an academic institution, a predicted likelihood of the student making SAP at the academic institution. One or more embodiments generate an intervention recommendation for the student in response to determining that the predicted likelihood does not satisfy a threshold criterion (e.g., meeting or exceeding a predetermined percentage likelihood).

In one example, a system monitors an application programming interface (API) of a computer system. While monitoring the API during a current academic period, the system detects a change in non-academic data exposed by the API. In response to detecting the change in the non-academic data, the system identifies a subset of the non-academic data that is associated with a particular student, and applies the trained machine-learning model to the subset of non-academic data to obtain a predicted likelihood of the particular student making SAP at the academic institution. In response to determining that the predicted likelihood of the particular student making SAP at the academic institution does not satisfy the threshold criterion, the system presents a warning in a graphical user interface (GUI) that the particular student is at risk of not making SAP.

One or more embodiments described in this Specification and/or recited in the claims may not be included in this General Overview section.

### 2. PRACTICAL APPLICATIONS

Prior approaches to determining a student's likelihood of making SAP are based on historical academic results. Because historical academic results reflect events that have happened in the past, prior approaches lack the technical ability to make proactive determinations about a student's likelihood of making SAP, for example, during a current academic period when academic results are not yet available. Additionally, prior approaches do not allow for proactive interventions during a current academic period when academic results are not yet available. For example, a student may fail to make SAP in their first semester, or may even fail out of an academic institution altogether based on their first-semester academic results. The lack of academic results prior to completing the first semester means that prior systems are not able to predict the student's likelihood of failing to make SAP in the first semester. After the student has completed the semester and historical academic results are available, the damage of not making SAP has already been done.

One or more embodiments disclosed herein provide a technical solution to the technical problem that prior approaches lack the technical ability to make proactive determinations about a student's likelihood of making SAP. Specifically, one or more embodiments described herein overcome this shortcoming by monitoring one or more A Pls of one or more computer systems that expose(s) non-academic data, and using the trained machine-learning model to determine a student's predicted likelihood of making SAP based at least in part on the non-academic data. Because non-academic data does not rely on historical academic results, one or more embodiments are able to predict a student's likelihood of making SAP even when historical academic results are unavailable. Additionally, one or more embodiments address this shortcoming by identifying correlations of risk factors that contribute to a student's predicted likelihood of making SAP based on non-academic data that a human might not consider.

### 3. EXAMPLE SYSTEM ARCHITECTURE

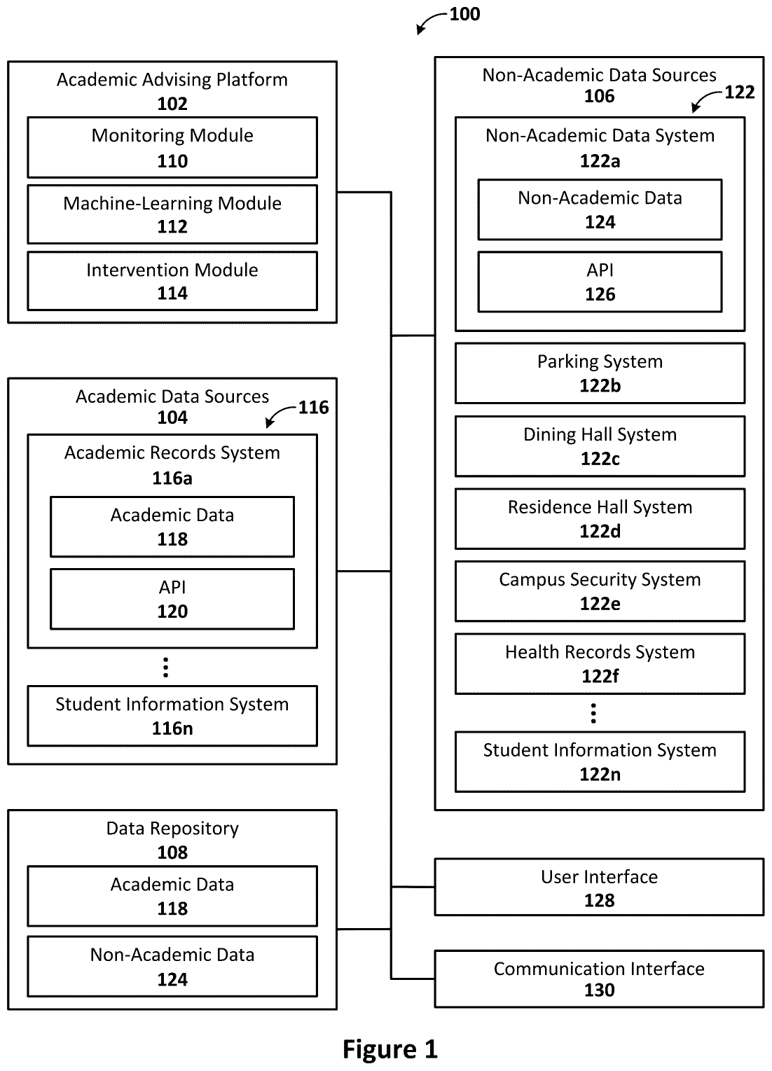

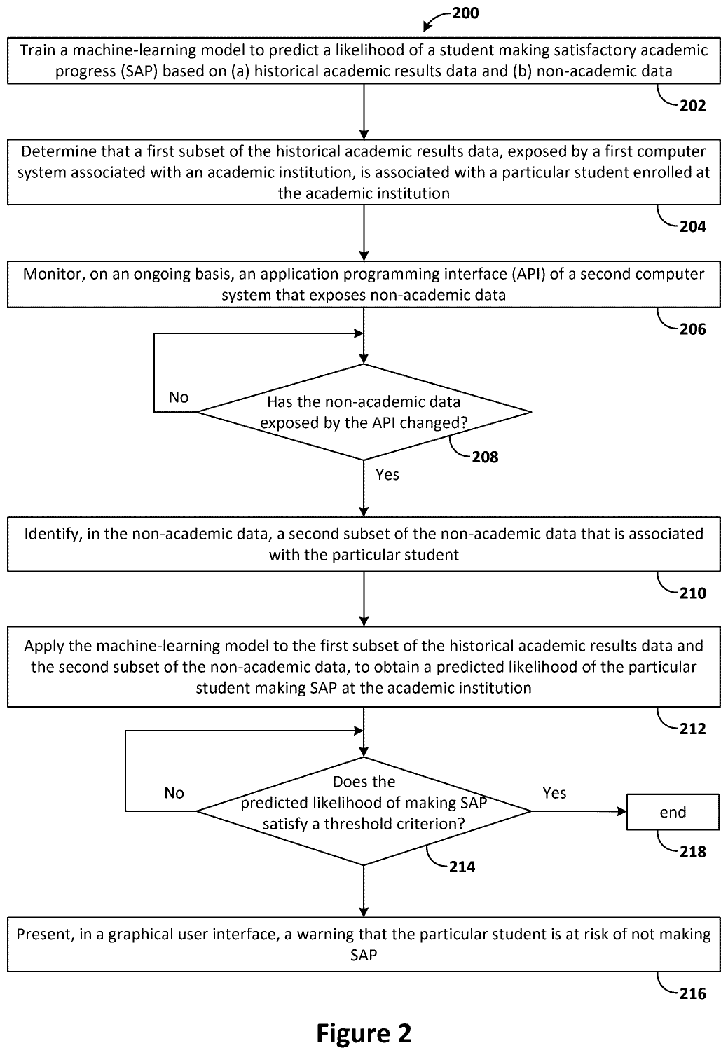

FIG. 1 is a block diagram that illustrates an example of a system 100 according to one or more embodiments. In one or more embodiments, the system 100 refers to hardware and/or software configured to perform operations described herein. Examples of operations are described below with reference to FIG. 2.

As shown in FIG. 1, the system 100 includes one or more of the following: an academic advising platform 102, one or mor academic data sources 104, one or more non-academic data sources 106, and a data repository 108. The academic advising platform 102 generates academic interventions for students of an academic institution. The students may include current or prospective students of an academic program, such as a course of study or degree program at a school or university. The system 100 may generate academic interventions for a student at various points in time during an academic program. The system 100 may generate academic interventions for prospective students, such as incoming students and/or transfer students. The academic interventions for prospective students may commence at the beginning of the academic program, for example, rather than waiting for a student to fail to make SAP.

The system 100 includes computing-based technology that integrates various software tools and databases for tracking students, identifying challenges and opportunities, and providing personalized interventions. The system 100 integrates datasets from computing systems that exist as a part of a large database and/or as part of a set of separate computing networks that are not otherwise in communication with one another. By accessing these datasets, the system 100 is able to utilize one or more machine-learning models to generate data-driven insights that are not otherwise available for determining academic performance predictions and/or academic interventions for students. The system utilizes information from these datasets to generate academic interventions in a proactive, timely, and/or cost-effective manner. The system 100 utilizes trigger event monitoring to obtain relevant information from the large volumes of data that are stored in these databases. Additionally, the system 100 utilizes trigger event monitoring to timely identify information that can impact academic performance predictions for a student and/or that can impact what academic interventions are appropriate for the student. Additionally, the system 100 operates continuously to initiate execution of academic intervention workflows promptly when trigger events are detected, for example, without needing to wait for a human to notice that an event has occurred. Additionally, the system utilizes one or more machine-learning models to determine trigger conditions to be monitored that would not be recognized by human analysis.

The system is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

As described herein, a ‘platform” or “module” refers to software, hardware, and/or firmware configured to perform the operations described herein with respect to that platform or module. For example, in an object-oriented environment, a platform or module may include one or more compiled class files and/or methods that, when executed, perform the corresponding operations.

In one or more embodiments, the system 100 may include more or fewer components than the components described with reference to FIG. 1. The components described with reference to FIG. 1 may be local to or remote from each other. The components described with reference to FIG. 1 may be implemented in software and/or hardware. The components of system 100 may be distributed over multiple applications and/or machines. Multiple components may be combined into one application and/or machine. Operations described with respect to one component may instead be performed by another component.

Additional embodiments and/or examples described below in the following sections: Section 6, titled “Example Machine-learning System;” Section 7, titled “Computer Networks and Cloud Networks;” Section 7, titled “Microservice Applications;” and Section 9, titled “Hardware Overview.” The system described with reference to FIG. 1 may include one or more features from one or more of these sections.

### A. Example Academic Advising Platform.

As shown in FIG. 1, the academic advising platform 102 includes a monitoring module 110, a machine-learning module 112, and an intervention module 114. The monitoring module 110 utilizes A Pls deployed to various sources of academic data and/or non-academic data to detect changes in the data. The monitoring module 110 may utilize webhook technology to enable real-time communication between the data sources and the academic advising platform 102, such as between the one or more academic data sources 104 and the academic advising platform 102 and/or between the one or more non-academic data sources 106 and the academic advising platform 102. In one example, for a particular data source, the monitoring module 110 supplies a uniform resource locator (URL) for receiving notifications of changes to data at the data source. The data source sends notifications of changes to the data to the URL supplied by the monitoring module 110. In an embodiment, the data source sends notifications when a predefined event is detected, which may be referred to as a trigger event. When the trigger event satisfies a predefined trigger condition, the data source sends an HTTP request to the URL. The HTTP request includes a payload that contains information about the trigger event. The payload may include an update that represents the change to the data at the data source. The monitoring module 110 may apply the update to data in the data repository 108 based on the payload received from the API. Additionally, or alternatively, the monitoring module 110 may retrieve data from the data source in response to the notification received from the API.

The machine-learning module 112 applies one or more machine-learning models to data in the data repository 108 to obtain outputs for the academic advising platform 102. The outputs may include an academic performance prediction for a particular student based on student information pertaining to the student. The academic performance predictions include a predicted likelihood of a student making SAP. The student information utilized by a machine-learning model may include academic data from one or more academic data sources 104 and/or non-academic data from one or more non-academic data sources 106. Additionally, the student information may include data stored in the data repository 108, such as academic data from the one or more academic data sources 104 and/or non-academic data from the one or more non-academic data sources 106. Additionally, or alternatively, the academic advising platform 102 may apply one or more machine-learning models to obtain academic interventions for particular students.

In an embodiment, a machine learning model generates an academic intervention for a particular student based on an academic performance prediction for the student and/or based on student information pertaining to the student. Additionally, or alternatively, the academic advising platform 102 may apply one or more machine-learning models to identify trigger conditions for performing operations associated with the system 100. The operations may include updating an academic performance prediction and/or an academic intervention for a student in response to a trigger event that satisfies a trigger condition. Additionally, or alternatively, the operations may include generating academic intervention workflows in response to trigger events that satisfy the trigger conditions.

The intervention module 114 of the academic advising platform 102 deploys the academic performance predictions and/or the academic interventions to nodes of one or more computing networks. The computing networks include various computing devices and A Pls executing on the computing devices for performing operations associated with the academic advising platform 102. The intervention module 114 may generate academic intervention workflows that can be executed by various nodes of the one or more computing networks. The academic interventions workflows may include operations associated with implementing academic interventions for students. The operations may include presenting information in a GUI pertaining to academic performance predictions and/or academic interventions corresponding to particular students. Additionally, or alternatively, the operations may include generating academic interventions and/or initiating execution of academic interventions in response to the trigger events. Additionally, or alternatively, the operations may include providing instructions to the monitoring module 110 to monitor for occurrences of trigger events that satisfy trigger conditions. In one example, the operations include providing instructions to the monitoring module 110 to update trigger conditions based on academic performance predictions and/or academic interventions.

As used herein, the term “trigger condition” refers to a set of one or more rules, criteria, or conditions that, when satisfied, provide a basis for the system to initiate execution of a set of one or more operations. A trigger condition may include a definition of the set of one or more rules, criteria, or conditions, and a definition of the set of one or more operations to be performed when the trigger condition is satisfied.

As used herein, the term “trigger event” refers to an event that satisfies a trigger condition. In one example, a trigger event may include a change in student information, such as a change in academic data and/or a change in non-academic data. In one example, a trigger event may include an output from a machine-learning model. In one example, a trigger condition may include set of rules, criteria, or conditions for evaluation against an output of the machine-learning model and an operation to be performed by the system when the output of the machine-learning model meets the set of rules, criteria, or conditions. In one example, the trigger event may include the machine-learning model generating an academic performance prediction for a student and/or the academic performance prediction meeting a threshold. Additionally, or alternatively, the trigger event may include a change in an academic performance prediction. In one example, a trigger event may include the machine-learning model generating an academic intervention for a student. Additionally, or alternatively, a trigger event may include a change in the academic intervention for the student.

In one example, a trigger event may include an alert or notification, for example, from an API, associated with information stored in one or more of: an academic data source 104, a non-academic data source 106, or a data repository 108. In one example, a trigger condition may include set of rules, criteria, or conditions for evaluation against an alert or notification and an operation to be performed by the system when the alert or notification meets the set of rules, criteria, or conditions. The alert or notification may correspond to an update (i.e., an addition or modification) to student information. Additionally, or alternatively, the alert or notification may correspond to an occurrence of one or more particular events represented by updated information in the data repository. For example, a trigger event may include an occurrence of an event and/or a pattern of events that may be indicative of a change in predicted academic performance. In one example, the trigger event may be associated with a student swiping a payment card at a dining facility. Additionally, or alternatively, the trigger event may be associated with a student using an access credential at an academic facility. Additionally, or alternatively, the trigger event may be associated with an incident report with campus security. Additionally, or alternatively, the trigger event may be associated with an approaching deadline and/or missing a deadline. The deadline may include applying for housing, financial aid, or student services. Additionally, or alternatively, the deadline may include registering for classes, or purchasing books or course materials.

### B. Example Data Sources and Data Repositories.

As shown in FIG. 1, the system utilizes data from academic data sources 104 and/or non-academic data source 106. The academic data sources 104 include one or more academic records systems 116, such as academic records system 116a and student information system 116n. The one or more academic records systems 116 include academic data 118 and an API 120 that provides notifications to the monitoring module 110 when the academic data 118 is updated. The non-academic data sources 106 include one or more non-academic data systems 122, such as non-academic data systems 122a-122n. The one or more non-academic data systems 122 include non-academic data 124 and an API 126 that provides notifications to the monitoring module 110 when the non-academic data 124 is updated. The non-academic data systems 122 may include one or more of the following: a parking system 122b, a dining hall system 122c, a residence hall system 122d, a campus security system 122e, a health records system 122f, or a student information system 122n.

Non-academic data associated with a parking system 122b may include information pertaining to students that parked a vehicle and when the vehicle was parked. The non-academic data associated with the parking system 122b may include one or more of the following: vehicle and driver information, parking session information, payment information, access and security data. Vehicle and driver information may include one or more of the following: vehicle ID (e.g., license plate number, VIN), vehicle type (e.g., car, motorcycle, truck); driver ID (e.g., user account ID, driver's license number), owner name, driver name, contact information (e.g., phone number, email), or parking permit or subscription ID. Parking session information may include one or more of the following: check-in time, check-out time, duration of stay, parking space ID or location (e.g., zone, floor, stall number), entry/exit gate used, session ID (unique identifier for the parking event), or payment status (paid/unpaid/overdue). Payment and information may include one or more of the following: payment method (e.g., credit card, mobile wallet, cash), rate applied (hourly, daily, flat, tiered), total amount charged, discounts or validations, or transaction ID. Access and security data may include one or more of the following: access credentials (e.g., RFID badge, mobile app token), surveillance footage metadata (e.g., timestamped vehicle movement), license plate recognition logs, alarm or incident logs, or barrier/gate activity records.

Non-academic data associated with a dining hall system 122c may include information pertaining to students that dined in a dining hall, and what food was purchased, and when. The non-academic data associated with the dining hall system 122c may include one or more of the following: student information, meal transaction data, food inventory data, access data, or payment data.

Student information may include one or more of the following: student ID, name, meal plan type (e.g., unlimited, pay-per-meal, guest pass), allergies or dietary restrictions, account balance, or meal credits. Meal transaction data may include one or more of the following: transaction ID, timestamp of entry (e.g., when student ID was scanned), meal type (e.g., breakfast, lunch, dinner, late-night), food items selected (e.g., grilled chicken, salad, soda), portion sizes (e.g., small, regular, double), calories or nutritional information (e.g., per food item, or per meal), or serving station used. Food inventory data may include one or more of the following: food item ID, food items available per meal period, ingredients, or nutritional information (e.g., calories, macro nutrients, allergens). Access data may include one or more of the following: swipe-in logs, mobile app access logs, entry point ID, transaction terminal ID, or denied access attempts (e.g., no remaining meal credits). Payment data may include one or more of the following: payment method (e.g., meal plan, credit/debit, cash), amount charged, or transaction ID.

Non-academic data associated with a residence hall system 122d may include data pertaining to who lives where, who comes and goes, and when. The non-academic data associated with the residence hall system 122d may include one or more of the following: residential information, room data, ingress and egress data, conduct records, or property management data.

Residential information may include one or more of the following: resident ID (e.g., student ID), name, affiliation (e.g., resident or guest), room assignment (e.g., building, floor, room number), move-in/move-out dates, roommate(s) info, or medical/disability accommodations. Room data may include one or more of the following: room ID, location (e.g., Hall A, Room 312B), room type (e.g., single, double, suite), occupancy status (vacant, occupied, reserved), room condition reports (e.g., at move-in/move-out), furniture inventory, or maintenance request logs. Ingress and egress data may include one or more of the following: access card swipes, entry/exit timestamps, entry/exit locations (e.g., front door, wing door, elevators), guest check-ins (e.g., visitor name, host, entry/exit time), or access denial events (e.g., expired ID, outside allowed hours). Conduct records may include one or more of the following: incident reports (e.g., noise complaints, rule violations), conduct hearings and outcomes, warnings, fines, lockouts, or key/card replacements. Property management data may include one or more of the following: housing contract or lease info, billing records (e.g., housing fees, damage charges), mail delivery logs, or utilities contracts, utilization, and payments.

Non-academic data associated with a campus security system 122e may include information pertaining to security events, who was involved, and when the events occurred. The non-academic data associated with the campus security system 122e may include one or more of the following: incident data, data pertaining to persons associated with the incident, security alert data,
Incident data may include one or more of the following: incident ID, type of incident (e.g., theft, trespassing, assault, fire alarm, medical emergency), date and time of incident, location (e.g., building name, GPS coordinates, camera ID), incident reports, security level or priority rating, responses or actions taken, or status (e.g., open, resolved, escalated, under investigation). Data pertaining to persons associated with the incident may include one or more of the following: person ID (e.g., student ID, staff ID, visitor ID), name, role in incident (e.g., victim, witness, suspect, responder), contact information, affiliation (student, faculty, contractor, unaffiliated), or associated organization (e.g., department, club, vendor). Security alert data may include one or more of the following: security alert messages (e.g., emergency notice, lockdown notice, weather alert), affected area, recipients, or timestamp.

Non-academic data associated with a health records system 122f may include information pertaining to students that have a health concern, what is the concern, and when the concern occurred. The non-academic data associated with the health records system 122f may include one or more of the following: student information (e.g., student ID, name), medical visit records (e.g., visit ID, date and time, location, reason for visit, symptoms reported), prognosis (e.g., condition, date of onset, duration, severity), wellness data, mental health data, screening data, or health alert data.

Non-academic data associated with a student information system 122n may include data that does not describe any kind of academic results. The non-academic data associated with the student information system 122n may include one or more of the following: student ID, name, date of birth, gender, citizenship, nationality, ethnicity, language(s) spoken, financial data (e.g., tuition payment status, financial aid status, scholarships, grants, stipends, billing info), or employment status (e.g., on campus, work study, position, title, pay rate, hours worked).

The system 100 may include one or more data repositories that store data utilized in connection with various operations of the system. The one or more data repositories 108 may include academic data 118 and/or non-academic data 124. The academic data 118 may be obtained from one or more academic data sources 104. The non-academic data 124 may be obtained from one or more non-academic data sources 106. In one example, the data repositories include data from different sources that allows one or more machine-learning models to identify indicators of academic performance that would not be apparent based on casual observation. In one example, the data repositories include data that conforms to the EDU-API data standard. When the data from different sources conforms to the EDU-API data standard, the data from the different sources may be seamlessly integrated for use by the system 100. In one example, the system transforms data into the EDU-API data standard from one or more other formats.

The one or more data repositories may include student information datasets associated with students. The system may utilize the student information datasets as training data for training the one or more machine-learning models. The student information datasets may include information about students that may be obtained from one or more academic data sources 104 and/or one or more non-academic data sources 106.

In one example, the student information datasets may include information maintained in a student information system. The student information system may include one or more data repositories associated with an academic institution. One or more nodes of the system may be associated with the student information system. The information maintained in a student information system may pertain to one or more of the following: personal information, enrollment information, academic records, attendance records, conduct records, health and wellness records, family information, relationship information, admissions, demographics, financial information, extracurricular activities, housing, transportation, academic advising, career planning, parking systems, campus security, access to facilities, institutional reporting, or attendance.

Additionally, or alternatively, the student information datasets may include information maintained in a financial aid system. The information maintained in the financial aid system may include information pertaining to financial aid applications and/or information pertaining to financial aid awards. The financial aid system may include one or more data repositories associated with a financial aid agency. One or more nodes of the system 100 may be associated with the financial aid system. The financial aid system and the student information system may represent separate systems from one another. Additionally, or alternatively, information from the financial aid system may be combined with, and/or may represent a portion of, the information in the student information system.

Additionally, or alternatively, the student information datasets may include information maintained in a social media monitoring and engagement system. The information maintained in a social media monitoring and engagement system may include information pertaining to social media activity of students. The social media monitoring and engagement system may include one or more data repositories that includes data pertaining to social media activity of students associated with one or more social media platforms. One or more nodes of the system 100 may be associated with the social media monitoring and engagement system. The social media monitoring and engagement system may be separate from the one or more social media platforms. The social media monitoring and engagement system may be separate from the student information system. Additionally, or alternatively, information from the social media system may be combined with, and/or may represent a portion of, the information in the student information system.

In one example, the one or more data repositories may include academic performance predictions for students. The academic performance predictions may include a predicted likelihood of making SAP. Additionally, or alternatively, the academic performance predictions may include a score that represents a predicted academic performance of a student. The academic performance may represent a level of academic progress at one or more stages of a course of study. An academic performance prediction may indicate a level of academic risk and/or a level of academic success that is predicted for a student. The academic performance predictions may correspond to academic performance bands or thresholds that represent different levels of performance or progress.

In one example, the one or more data repositories may include data that describes academic interventions for students. The academic interventions may include one or more of the following: instructional interventions, behavioral interventions, academic support programs, advisor meetings, instructor meetings, office hours, tutoring, study groups, social-emotional interventions, organizational interventions, technological interventions, academic planning or course selection interventions, performance monitoring, personalized support, graduation or retention initiatives, skills development interventions, or resource referrals. In one example, the academic intervention includes booking an appointment with an advisor.

Additionally, or alternatively, the one or more data repositories may include definitions of trigger conditions for performing operations associated with the system 100 in response to trigger events that satisfy the trigger conditions. The operations may include generating academic intervention workflows in response to trigger events that satisfy trigger conditions. Additionally, or alternatively, the operations may include updating academic performance predictions and/or academic interventions in response to trigger events that satisfy trigger conditions.

In one example, the one or more data repositories 108 may include academic outcome datasets associated with students. The system 100 may utilize the academic outcome datasets to train and/or retrain the one or more machine-learning models. Additionally, or alternatively, the system 100 may utilize the academic performance predictions and/or the academic interventions for students to train and/or retrain the one or more machine-learning models.

In one example, an academic outcome dataset may include academic outcomes, such as scores or grades for assignments, tests, or courses. The scores or grades may represent distinct results, midterm results, or final results associated with one or more academic course.

In one example, the academic outcome dataset may include changes to academic performance predictions, for example, as a result of performing academic interventions. Additionally, or alternatively, the academic outcome dataset may include changes in academic interventions, for example, as a result of a change in one or more academic outcomes and/or a change in one or more academic performance predictions. Additionally, or alternatively, the academic outcome dataset may include changes to trigger conditions, for example, associated with a change in one or more of the following: academic outcomes, predicted academic performance, and/or academic interventions.

In one or more embodiments, a data repository includes any type of storage unit and/or device (e.g., a file system, database, collection of tables, or any other storage mechanism) for storing data. Further, a data repository may include multiple different storage units and/or devices. The multiple different storage units and/or devices may or may not be of the same type or located at the same physical site. Further, a data repository may be implemented or executed on the same computing system as the system 100. Additionally, or alternatively, the data repository may be implemented or executed on a computing system separate from the system 100. The data repository may be communicatively coupled to the system 100 via a direct connection or via a network.

### C. Example Machine-Learning Models.

The system 100 includes one or more machine-learning models. The one or more machine-learning models are trained based on training data from the one or more data repositories 108. The machine-learning module 112 applies one or more machine-learning models to obtain an academic performance prediction for a student based on a student information dataset pertaining to the student. In one example, the machine-learning module 112 applies one or more machine-learning models to obtain a predicted likelihood of a particular student making SAP at an academic institution. Additionally, or alternatively, a machine-learning model may generate an academic intervention for the student. The machine-learning model may generate the academic intervention for the student based on at least the student information dataset pertaining to the student or the academic performance prediction for the student. Additionally, or alternatively, a machine-learning model may generate a set of one or more trigger conditions for updating the academic performance prediction and/or the academic intervention for the student. The machine-learning model may generate the set of one or more trigger conditions based on the student information dataset pertaining to the student, the academic performance prediction, and/or the academic intervention.

A machine-learning model may include one or more machine-learning algorithms, such as supervised algorithms and/or unsupervised algorithms. Various types of algorithms may be used, such as linear regression, logistic regression, linear discriminant analysis, classification and regression trees, naïve Bayes, k-nearest neighbors, learning vector quantization, support vector machine, bagging, and random forest, boosting, backpropagation, and/or clustering. In addition, or in the alternative, to a machine-learning model, the system 100 may utilize one or more classical models. A classical model may include one or more classical statistical algorithms that rely on a set of assumptions about one or more of the underlying data, the data generating process, or the relationships between the variables. Example classical statistical algorithms may include linear regression, logistic regression, ANOVA (analysis of variance), or hypothesis testing.

In one example, a machine-learning algorithm can be iterated to learn a target model f that best maps a set of input variables to an output variable. In particular, a machine-learning algorithm may be configured to generate and/or train a machine-learning model. A machine-learning algorithm may be iterated to learn a target model f that best maps a set of input variables to an output variable, using a set of training data. Training data used by a machine-learning algorithm may be stored in a training data corpus, for example, in the data repository. The training data may include datasets and associated labels. The datasets may be associated with input variables for the target model f. The associated labels may be associated with the output variable of the target model f. The training data may be updated based on, for example, feedback on the accuracy of the current target model f. Updated training data may be fed back into the machine-learning algorithm, that in turn updates the target model f.

A machine-learning algorithm may generate a target model f such that the target model f best fits the datasets of training data to the labels of the training data. Additionally, or alternatively, a machine-learning algorithm may generate a target model f such that when the target model f is applied to the datasets of the training data, a maximum number of results determined by the target model f matches the labels of the training data. Different target models may be generated based on different machine-learning algorithms and/or different sets of training data.

In one example, the system 100 may include a model trainer that utilizes one or more machine-learning algorithms to generate and/or train a machine-learning model. In one example, the model trainer may obtain and/or generate feedback from one or more of the machine-learning models. The model trainer may train, update, and/or retrain one or more of the machine-learning models based at least in part on the feedback. The feedback may correspond to one or more outputs of at least one machine-learning model. In one example, the model trainer may obtain one or more training datasets. The model trainer may train a machine-learning model based at least in part on the one or more training datasets.

The training datasets may include datasets from the data repository 108, such as student information datasets associated with students, including academic data and/or non-academic data. The training datasets may include one or more of the following: academic performance predictions and/or academic interventions for the students, trigger conditions for updating the academic performance predictions and/or the academic interventions, or academic outcome datasets associated with the students. In one example, the training data may include outputs from one or more of the machine-learning models, such as the academic performance predictions and/or the academic interventions for the students. Additionally, or alternatively, the training data may include academic outcome datasets associated with the students that indicate how well the machine-learning model performed in outputting the academic performance predictions and/or the academic interventions. For example, a machine-learning model may be iteratively trained and/or re-trained based at least in part on outputs generated by one or more of the machine-learning models. A machine learning model may be improved iteratively over time as additional datasets are analyzed by the machine-learning model to produce additional outputs, and the machine learning model is iteratively trained or re-trained based on the additional outputs.

In one example, the training data may include one or more initial supervised learning datasets. The model trainer may train a machine-learning model based at least in part on the one or more initial supervised learning datasets. In one example, the training data may include one or more subsequent supervised learning datasets. The model trainer may update or retrain the machine-learning model based on one or more subsequent supervised learning datasets. The one or more subsequent supervised learning datasets may be generated based at least in part on feedback corresponding to one or more outputs of the machine-learning model.

In one example, a machine-learning model generates outputs that include academic performance predictions, academic interventions, and/or trigger conditions for monitoring based on information that a human would not correlate with academic performance and/or that a human would consider surprising. In one example, a machine-learning model generates outputs based on a mutual information score. The mutual information score represents an amount of information that one variable provides about another. A high mutual information score combined with a low correlation may represent a surprising relationship. In one example, a machine-learning model generates outputs that fall outside of a recognized pattern, such as a correlation that was not previously recognized by the model and/or a correlation that was not previously recognized in the field of academic advising. In one example, a machine learning model generates outputs that have a high complexity measure, such as a high Kolmogorov complexity. A complexity measure, such as a Kolmogorov complexity, represents a measure of the computational resources needed to describe a dataset. A high complexity measure indicates that a human would not be able to describe the dataset with a mental process. Additionally, or alternatively, a machine-learning model may generate outputs that result in reducing a complexity measure when considering a correlation determined by the machine-learning model. A reduction of the complexity measure when considering a correlation determined by the machine learning model may indicate that the correlation is surprising and/or that the correlation would not be identified by a mental process. In one example, a machine-learning model generates outputs based on a correlation that contradicts a set of one or more known heuristics. A correlation that contradicts a set of one or more know heuristics indicates that a human would find the correlation surprising.

### D. Example System Interfaces.

The system 100 may include a user device interface 128 communicatively coupled or couplable with one or more other components of the system 100. A user device interface 128 may include hardware and/or software configured to facilitate interactions between a user and various aspects of the system 100. The user device interface 128 may render user interface elements and receive input via user interface elements. For example, the user device interface 128 may display outputs generated by the system 100. Additionally, or alternatively, the user device interface 128 may be configured to provide inputs to the system 100. Examples of interfaces include a GUI, a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by a user device interface 128.

In an embodiment, different components of a user device interface 128 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, a user device interface 128 may be specified in one or more other languages, such as Java, C, or C++.

Additionally, or alternatively, the system 100 may include one or more communications interfaces 130 communicatively coupled or couplable with one or more components of the system 100. The one or more communications interfaces 130 may include hardware and/or software configured to transmit data between respective components of the system 100 and/or to transmit data to and/or from the system 100. For example, a communications interface 130 may transmit and/or receive data between and/or among one or more components of the system 100.

### 3. EXAMPLE OPERATIONS

Referring to FIGS. 2, example operations 200 pertaining to the system are further described. One or more operations 200 described with reference to FIG. 2 may be modified, combined, rearranged, or omitted. Accordingly, the particular sequence of operations 200 described with reference to FIG. 2 should not be construed as limiting the scope of one or more embodiments. In one example, the operations 200 may be performed by the one or more components of the system described herein.

A. Generating Warnings that a Particular Student is at Risk of not Making Satisfactory Academic Progress

Referring to FIG. 2, the system predicts a likelihood of a particular student making SAP at an academic institution where the student is enrolled and generates a warning for display in a GUI when the predicted likelihood of making SAP is below a threshold criterion. As shown in FIG. 2, a system trains a machine-learning model to predict a likelihood of a student making satisfactory academic progress (SAP) based on (a) historical academic results data and (b) non-academic data (Operation 202). The system may obtain the historical academic results data from one or more academic data sources, such as an academic records system or a student information system. The system may obtain the non-academic data from one or more non-academic data sources. The system may tarin the machine-learning model based on one or more training datasets.

The system determines that a subset of the historical academic results data is associated with a particular student enrolled at the academic institution (Operation 204). In one example, the historical academic results data indicates grades obtained by the particular student for one or more previous academic periods. Additionally, or alternatively, the historical academic results data may indicate that the particular student has not yet completed any academic period at the academic institution. The historical academic results data may be exposed by a computer system associated with the academic institution. The computer system associated with the academic institution may include an API that exposes the historical academic results data. The system may store the historical academic results data in a data repository. The system may monitor the API to obtain the historical academic results data.

Additionally, the system monitors, on an ongoing basis, an API of a computer system that exposes non-academic data (Operation 206). The system may monitor the API by periodically querying the API. Additionally, or alternatively, the system may receive notifications from the API when the non-academic data changes. The notifications may be directed to a URL designated for receiving notifications of changes to the non-academic data from the API. The system may monitor the URL for notifications.

Based on monitoring the API, the system determines whether the non-academic data exposed by the API changed (Operation 208). The system may determine that the non-academic data has changed when the API responds to a query with an update to the non-academic data. Additionally, or alternatively, the system may determine that the non-academic data has changed when an update from the API arrives at the URL designated for receiving notifications of changes to the non-academic data from the API.

If the system determines that the non-academic data has not changed, the system continues monitoring the API. When the system determines that the non-academic data has changed, the system identifies, in the non-academic data, a subset of the non-academic data that is associated with the particular student (Operation 210). The system may determine that a subset of the non-academic data is associated with a particular student based on identifying information in the non-academic data, such as a student ID or a student name. The system may map the identifying information in the non-academic data to academic data, such as the historical academic results data, to identify the subset of non-academic data that is associated with the particular student.

After identifying the subset of non-academic data that is associated with the particular student, the system applies the machine-learning model to the subset of the historical academic results data and the subset of the non-academic data, to obtain a predicted likelihood of the particular student making SAP at the academic institution (Operation 212). The system may apply the machine-learning model by directing a message to the machine-learning model that instructs the machine-learning model to execute operations for generating the predicted likelihood of the particular student making SAP at the academic institution. The message may include the subset of the historical academic results data and/or the subset of the non-academic data. Additionally, or alternatively, the system may identify a location in a data repository where the machine learning model can retrieve the subset of the historical academic results data and/or the subset of the non-academic data. When the machine-learning model generates the predicted likelihood of the particular student making SAP at the academic institution, the machine-learning model outputs a message that indicates the predicted likelihood of making SAP.

When the system receives the predicted likelihood of making SAP, the system determines whether the predicted likelihood of making SAP satisfies a threshold criterion (Operation 214). If the system determines that the predicted likelihood of making SAP does not satisfy the threshold criterion, the system presents, in a GUI, a warning that the particular student is at risk of not making SAP (Operation 216). To present the warning, the system may pass the name of the student and an indication that the student is at risk of not making SAP to a GUI component. The system may pass information to the GUI component directly and/or via a data binding mechanism. The GUI component updates an internal state with the information passed by the system. The update to the internal state triggers a redraw operation. The redraw operation includes executing a rendering engine to convert the information passed to the GUI component into visible pixels on a display device.

The operations with respect to the particular student may end if the system determines that the predicted likelihood of making SAP satisfies the threshold criterion (Operation 218). Additionally, or alternatively, the system may present, in the GUI, an indication of the predicted likelihood of the particular student making SAP. Additionally, or alternatively, the system may continue monitoring the API for non-academic data and/or the system may receive additional non-academic data from the API. The system may reapply the machine-learning model to additional non-academic data received from the API. In one example, after a current academic period has completed, the system may detect a change in the historical academic results data and may retrain the machine-learning model based on the change in the historical academic results data. The change in the historical academic results data may represent posting of grades for the academic period that has completed.

### 5. EXAMPLE EMBODIMENTS

A detailed example is described below for purposes of clarity. Components and/or operations described below should be understood as one specific example which may not be applicable to certain embodiments. Accordingly, components and/or operations described below should not be construed as limiting the scope of any of the claims.

### A. Example Academic Advising Platform.

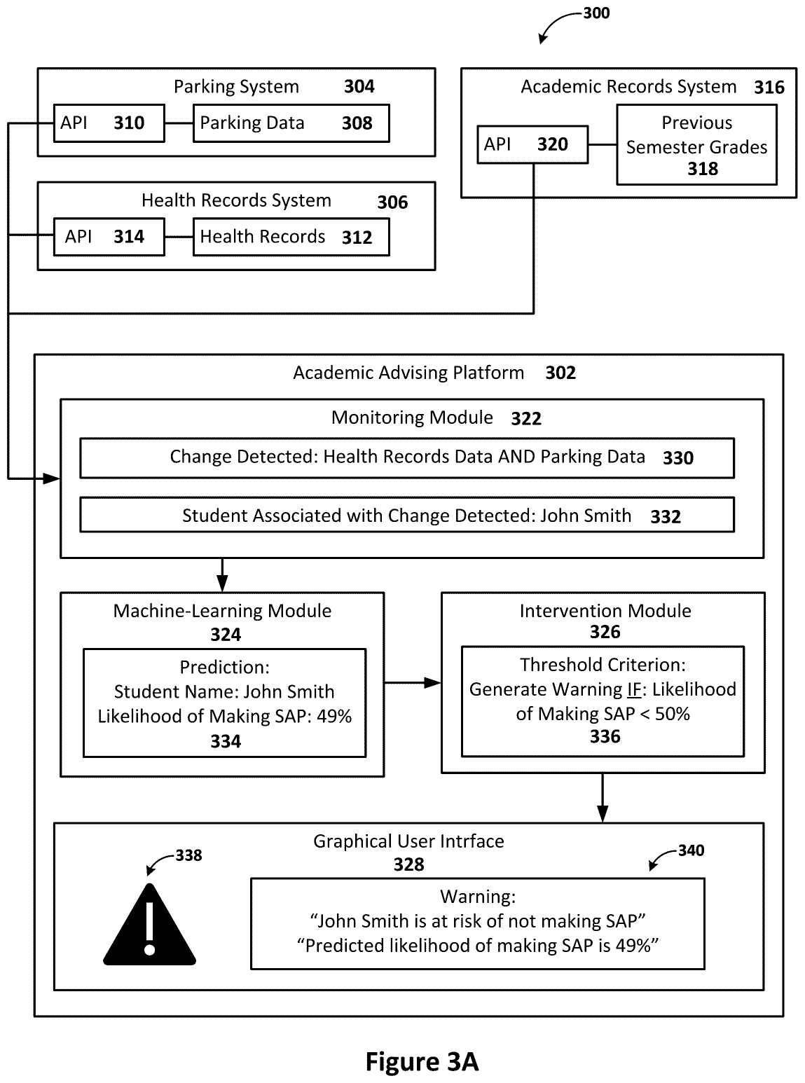

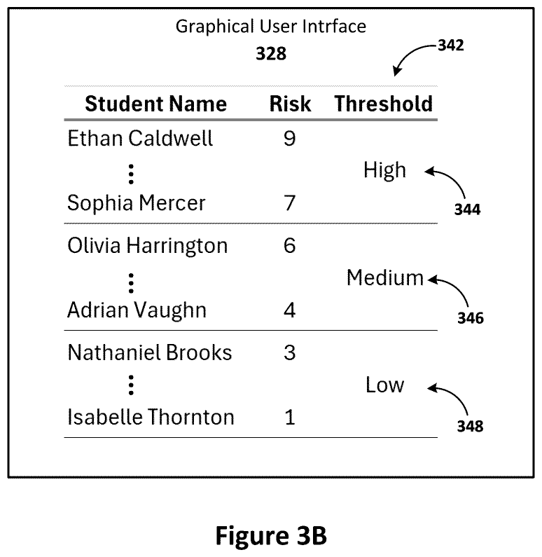

FIGS. 3A and 3B show an example implementation of methods and features described herein. As shown in FIG. 3A, a system 300 includes an academic advising platform 302. The academic advising platform 302 receives non-academic data from one or more non-academic data sources, such as a parking system 304 and a health records system 306. The non-academic data received from the parking system 304 includes parking data 308. The parking system 304 includes an API 310 that provides updated parking data to the academic advising platform 302. The non-academic data received from the health records system 306 includes health records 312. The health records system 306 includes an API 314 that provides updated health records data to the academic advising platform 302. Additionally, the academic advising platform 302 receives academic data from an academic records system 316. The academic data received from the academic records system 316 includes previous semester grades 318. The academic records system 316 includes an API 320 that provides the previous semester grades to the academic advising platform 302.

The academic advising platform 302 includes a monitoring module 322, a machine-learning module 324, an intervention module 326, and a GUI 328. The monitoring module 322 detects a change 330 in the health records data and the parking data. Additionally, the monitoring module 322 identifies a particular student associated with the detected change 332. The monitoring module may identify the particular student based on the previous semester grades and/or the non-academic data, such as the health records data and the parking data. For example, the system may extract a name of the student from the previous semester grades and/or from the non-academic data. As shown in FIG. 3A, the particular student is John Smith.

The monitoring module 322 directs a message to the machine-learning module 324 to instruct the machine-learning module 324 to apply a machine-learning model to obtain a predicted likelihood of John Smith making SAP. The machine-learning module 324 directs an input the machine-learning model to instruct the machine-learning model to generate the predicted likelihood of making SAP. The machine-learning model generate an output that includes the predicted likelihood of making SAP and direct the output to the machine-learning module 324. As shown in FIG. 3A, the output from the machine-learning model indicates that the predicted likelihood 334 of John Smith making SAP is 49%.

The machine-learning module 324 directs a message to the intervention module 326 to instruct the intervention module to determine whether the predicted likelihood of John Smith making SAP satisfies a threshold criterion 336. As shown in FIG. 3A, a predicted likelihood of less than 50% does not meet the threshold criterion 336. Additionally, the threshold criterion 336 triggers the intervention module to generate a warning if the threshold criterion 336 is unmet. In response to the threshold criterion 336 being unmet by the predicted likelihood 334, the intervention module directs a message to the GUI 328 to instruct the GUI 328 to present a warning for display in the GUI 328 indicating that John Smith is at risk of not making SAP. In one example, the GUI 328 presents a graphical warning 338. Additionally, or alternatively, the GUI 328 may present a textual warning 340. As shown in FIG. 3A, the textual warning states that John Smith is at risk of not making SAP. Additionally, the textual warning states that the predicted likelihood of making SAP is 49%.

As shown in FIG. 3B, in one example, the GUI 328 may display a table 342 that includes information pertaining to multiple students. In one example, the table 342 may include a risk level. Additionally, or alternatively, the table may include one or more thresholds that correspond to particular risk levels. For example, as shown in FIG. 3B, risk of not making SAP is scaled from 1 to 10. A high risk threshold 344 corresponds to a risk of from 7 to 10. A medium risk threshold 346 corresponds to a risk of from 4 to less than 7. A low risk threshold 348 corresponds to a risk of less than 4.

Academic advisors may utilize the information presented in the GUI to proactively provide academic interventions for students, including students that have various predicted likelihoods of making SAP and various risk levels of not making SAP. Additionally, or alternatively, the academic advising platform may generate academic interventions for students, for example, based on the student's predicted likelihood of making SAP and/or risk of not making SAP.

### B. Training Machine Learning Models.

In one example, the system performs operations pertaining to training one or more machine-learning models. The system receives training data from a set of one or more data repositories. The training data may include student information datasets and/or academic outcome datasets. Additionally, or alternatively, the training data may include academic outcome datasets. The system trains one or more machine-learning models based on the training data, as described in further detail herein. Different training data may be utilized to train different machine-learning models.

In one example, the system trains a machine-learning model to generate an academic performance prediction for a student. The machine-learning model may generate the academic performance predication based on a student information dataset pertaining to the student.

In one example, the system trains a machine-learning model to generate an academic intervention for the student of the system. The machine-learning model may generate the academic intervention based on the student information dataset and/or the academic performance prediction.

In one example, the system trains a machine-learning model to generate a set of one or more trigger conditions for performing operations associated with the system. The machine-learning model may generate the set of one or more trigger conditions based on at least one of the following: the student information dataset, the academic performance prediction, or the academic intervention. The machine-learning model may generate academic performance predications, academic interventions, and/or trigger conditions for updating the academic performance predications and/or academic interventions for multiple students.

In one example, the system monitors one or more data repositories to determine whether additional training data is available. The system may train and/or retrain one or more machine-learning models when additional training data is available. The system determines whether additional training data been added to the set of one or more data repositories. When the system determines that additional training data has been added to a data repository, the system may train and/or retrain the one or more machine-learning models based on the additional training data.

### C. Generating and Deploying Academic Predictions, Academic Interventions, and Trigger Conditions.

In one example, the system performs operations pertaining to generating one or more of the following: academic performance predictions, academic interventions, or trigger conditions for updating academic performance predictions and/or academic interventions. Additionally, the system may perform operations pertaining to deploying academic performance predictions, academic interventions, and/or trigger conditions to one or more nodes of the system.

The system identifies a student information dataset pertaining to a student. The participation information dataset may be located in a data repository. The system generates an academic performance prediction for the student based on the student information dataset. The system may utilize a machine-learning model to generate the academic performance prediction. The machine-learning model may be trained to generate the academic performance prediction based on the student information dataset. The machine-learning model may generate multiple academic performance predictions for a particular student. The machine-learning model may generate academic performance predictions for a particular student that correspond to different courses and/or different areas of study. The machine-learning model may generate academic performance predictions for a particular student that correspond to different time periods and/or degree programs. Additionally, or alternatively, the machine-learning model may generate multiple academic performance predictions that are tailored for receipt by different recipients. For example, the content and/or messaging of the academic performance prediction may be tailored for different recipients. In one example, the machine-learning model may generate a first academic performance prediction for a student that is intended for viewing by the student and a second academic performance prediction that is intended for viewing by an administrator or by an academic advisor.

Additionally, or alternatively, the system generates an academic intervention for the student. The system generates the academic intervention based on the student information dataset and/or the academic performance prediction. The system may utilize a machine-learning model to generate the academic intervention. The machine-learning model may be trained to generate the academic intervention based on the student information dataset and/or the academic performance prediction.

The machine-learning model may generate academic interventions for a particular student that correspond to different categories of intervention and/or for different courses and/or areas of academic study. Additionally, or alternatively, the machine-learning model may generate academic interventions that are intended for different parties or entities that are involved in implementing the intervention. In one example, the machine-learning model may generate a set of one or more academic interventions that are intended to be implemented by the student. Additionally, or alternatively, the machine-learning model may generate a set of one or more academic interventions that are intended to be implemented by an academic professional such as an academic advisor, an instructor, or a teaching assistant. Additionally, or alternatively, the machine-learning model may generate a set of one or more academic interventions that are intended to be implemented by a computing system without human intervention. Additionally, or alternatively, the machine-learning model may generate a set of one or more academic interventions that are intended to be monitored by an administrator. The machine-learning model may tailor the content of the academic interventions for the intended recipient. In one example, the machine-learning model may determine a tone, content, or style based on the intended recipient.

Additionally, or alternatively, the system generates a set of one or more trigger conditions for performing operations of the system with respect to the student. In one example, the system may generate one or more trigger conditions for updating the academic performance prediction and/or the academic intervention for the student. Additionally, or alternatively, the system may generate one or more trigger conditions for initiating a set of one or more academic intervention workflows with respect to the student.

The system generates the set of one or more trigger conditions based on at least one of the following: the student information dataset, the academic performance prediction, or the academic intervention. The system may utilize a machine-learning model to generate the set of one or more trigger conditions. The machine-learning model may be trained to generate the set of one or more trigger conditions based on at least one of the following: the student information dataset, the academic performance prediction, or the academic intervention.

After generating the academic performance prediction, the academic intervention, and/or the set of one or more trigger conditions, the system deploys these items to one or more nodes of the system. The nodes include components of a distributed computing system. In one example, the nodes include application programming interfaces (APIs) that perform operations associated with the system. The system selects the nodes based on one or more of the following: one or more items of student information, the academic performance prediction, the academic intervention, or the trigger conditions.

In one example, the one or more nodes include a GUI generation API that generates GUIs for displaying information on a user device interface. In one example, a GUI generated by the GUI generation API includes a set of academic performance predictions and/or a set of the academic interventions for a student. In one example, the GUI generation API is located on a computing device associated with the student. The GUI generation API generates a GUI that includes the set of academic performance predictions and/or a set of the academic interventions for the student and render the GUI for display on a user device interface of the computing device. In one example, the GUI generation API is located on a node of the system. The GUI generation API generates one or more GU Is that include academic performance predictions and/or academic interventions associated with one or more students. The GUI generation API may render the one or more GUIs for display on a user device interface of one or more computing devices that are utilized, for example, by academic advisors, faculty, teaching assistants, or tutors in connection with providing academic interventions for students.

In one example, the one or more nodes include an academic intervention API. The academic intervention API may deliver one or more academic interventions to a student via a computing device associated with the student. The student may interact with the academic intervention API via a GUI that is generated by the academic intervention API and rendered for display on a user device interface of the computing device.

In one example, the one or more nodes include an event handler that generates event objects associated with trigger conditions. The event objects may listen for an occurrence of one or more trigger events that satisfy one or more trigger conditions. In one example, the event objects continuously listen for trigger events. In one example, the event objects periodically check for trigger events. The system may select the continuous or periodic nature of the event objects based on the particular trigger conditions. By continuously or periodically listening for trigger events, the system may promptly respond to trigger events when they occur.

In one example, the event objects are deployed within the system. The event objects may listen for trigger events based on data received by the system. For example, the event objects may listen for trigger events based on updates to data in a student information system. Additionally, or alternatively, the event objects may be deployed to other computing systems that are logically or physically separated from the system. The event handler may generate listening requests and transmit the listening request for an event handling agent associated with a computing system that is logically or physically separated from the system. The listening request may include the event object. Additionally, or alternatively, the event handling agent may generate the event object in response to the listening request. The event handling agent may deploy the event object to listen for trigger events. In response to detecting a trigger event, the event handling agent may transmit a notification of the trigger event to the event handler of the system. The event handler receives the notification of the trigger event and initiates one or more operations in response to the trigger event. In one example, the event handler initiates generation and/or execution of a workflow in response to the notification of the trigger event. The workflow may include one or more operations in response to the trigger event, such as one or more of the following: initiating an academic intervention, generating an updated academic performance prediction, generating an updated academic intervention, or generating a set of updated trigger conditions.

Additionally, or alternatively, the system may monitor utilizing a “pull” scenario where the system polls one or more databases for new/updated data periodically and/or in response to events that trigger the polling. In one example, the system initiates a polling operations in response to an occurrence of a trigger event. Additionally, or alternatively, the system may determine an occurrence of a trigger event in response to data obtained from a polling operation.

In one example, the one or more nodes include a workflow generation engine. The workflow generation engine generates workflows based on academic performance predictions, academic interventions, and/or trigger events that satisfy trigger conditions. In one example, a workflow may include transmitting academic performance predictions, academic interventions, and/or trigger conditions to various nodes. Additionally, or alternatively, a workflow may include delivering academic interventions. Additionally, or alternatively, a workflow may include generating event objects for listening for trigger events and/or generating listening requests and transmit the listening requests to event handling agents.

The system determines whether the data repository includes an additional student information dataset. The additional student information dataset may be associated with an additional student of the system. The additional student may represent a student associated with a student information dataset that has yet to be processed by the system. For example, the additional student information dataset may be in a queue of the data repository that includes student information datasets associated with multiple students that are awaiting processing. Additionally, or alternatively, the additional student information dataset may be associated with a new student of the system. Additionally, or alternatively, the additional student information dataset may be associated with a student that the system has already generated an academic performance prediction, an academic intervention, and/or a set of one or more trigger conditions for updating the academic performance prediction and/or the academic intervention. For example, the additional student information dataset may represent an update to an existing student information dataset. When the system determines that the data repository includes an additional student information dataset, the system proceeds to generate, based on the additional participation information dataset, an academic performance prediction, an academic intervention, and/or a set of one or more trigger conditions for updating the academic performance prediction and/or the academic intervention.

### D. Updating Predictions and Interventions in Response to Trigger Events.

In one example, the system performs operations pertaining to generating updated academic performance predictions and/or updated academic interventions in response to trigger events that satisfy trigger conditions. The system monitors for trigger events that satisfy a set of one or more trigger conditions for generating or updating one or more academic performance predictions and/or one or more academic interventions for a set of students. The set of trigger conditions may include a subset of trigger conditions that are monitored for the set of students, for example, by default. Additionally, or alternatively, the set of trigger conditions may include, for a particular student, one or more trigger conditions that are monitored specifically for the particular student. The one or more trigger conditions that are monitored specifically for the particular student may be determined, for example, by a machine-learning model, based on the student information dataset, the academic performance prediction, and/or the academic intervention for the particular student. The system may utilize an event handler to monitor for trigger events. The event handler may generate event objects corresponding to various trigger conditions. The event objects may generate a notification upon the occurrence of the trigger events. Additionally, or alternatively, the event handler may transmit listening requests to event handling agents associated with other computing systems that are logically or physically separated from the system. The event handler receives the notification of the trigger event and initiates one or more operations in response to the trigger event.

The system determines whether a trigger event has occurred for updating one or more academic performance predictions and/or one or more academic interventions. In one example, the system utilizes an event handler to determine occurrences of trigger events. In one example, an event object deployed by the event handler generates a notification of a trigger event in response to detecting an occurrence of a trigger event. In one example, an event handling agent transmits a notification of a trigger event to the event handler in response to detecting an occurrence of a trigger event. The notification of the trigger event may include a trigger condition identifier. The system may determine information about one or more trigger conditions that are satisfied by the trigger event based on the trigger condition identifier.

In response to determining an occurrence of a trigger event, the system determines a student associated with the trigger event. One or more students may be associated with the trigger event. In one example, the data repository includes a mapping of trigger condition identifiers to one or more students that are associated with particular trigger events.

Upon having determined a student associated with the trigger event, the system determines one or more operations to perform in response to the trigger event. The one or more operations may be defined by a trigger condition that is satisfied by the trigger event. Additionally, or alternatively, the trigger condition may be mapped to one or operations to perform in response to a trigger event that satisfies the trigger condition. The one or more operations may include updating the academic performance prediction and/or updating the academic intervention for a student in response to the trigger event. In one example, the data repository includes a mapping of trigger condition identifiers and/or students to one or more operations for the system to perform in response to trigger events that satisfy the trigger condition. The one or more operations to perform may depend on the particular trigger conditions and/or the particular student. For example, in response to a trigger event that satisfies trigger condition X, the system may perform operation A with respect to student Y and operation B with respect to student Z, where operation A and operation B are different from one another. Additionally, or alternatively, in response to a trigger event that satisfies trigger condition W, the system may perform operation A with respect to student Z and operation D with respect to student Z, where trigger condition W and trigger condition X are different from one another. The system may perform the same action in response to different trigger events and/or in response to different trigger conditions that are satisfied by a trigger event. In the preceding example, the system performs operation A with respect to student Y in response to a trigger event that satisfies trigger condition X and the system performs operation A with respect to student Z in response to a trigger event that satisfies trigger condition W.

The system determines whether the updated academic performance prediction and/or the updated academic intervention represent a change with respect to the student. When the updated academic performance prediction and/or the updated academic intervention represents a change with respect to the student, the system deploys the updated academic performance prediction and/or the updated academic intervention to one or more nodes of the system.

In one example, when the updated academic performance prediction and/or the updated academic intervention represents a change with respect to the student, the system generates a set of one or more updated trigger conditions for further updating at least one of the academic performance prediction or the academic intervention for the student. In this manner, the system is configured to reconfigure its own event monitoring behavior in response to changes in academic performance predictions. For example, when academic performance prediction X is associated with student A, the system may determine that trigger condition Y should be monitored with respect to student A. When academic performance prediction X is updated to become academic performance prediction W, the system may determine that trigger condition Z should be monitored with respect to student A in addition or in the alternative to trigger condition Y. Additionally, or alternatively, when academic intervention Q is associated with student B, the system may determine that trigger condition T should be monitored with respect to student B. When academic intervention Q is updated to become academic intervention R, the system may determine that trigger condition U should be monitored with respect to student B in addition or in the alternative to trigger condition T.

In one example, the system generates updated trigger condition associated with one or more students as conditions change over time. The changes in academic performance predictions can include one or more of the following: an improvement, a deterioration, a regression, a stagnation, a step change, or a trend. For example, as an academic performance prediction for a student changes from X, to Y, to Z over time, the system may modify the trigger condition that the system monitors for initiating execution of operations with respect to the student. The operations can include determining updated trigger condition and/or determining updated academic interventions and/or corresponding workflow. When the academic performance prediction for a student is X, the system may determine that trigger condition R and trigger condition S should be monitored. When the academic performance prediction for the student changes from X to Y, the system may determine that trigger condition T should be added to the set of trigger conditions that the system is monitoring and/or that trigger condition R should be removed from the set of trigger conditions that the system is monitoring. When the academic performance prediction for the student changes from Y to Z, the system may determine that trigger condition U should be added to the set of trigger conditions that the system is monitoring and/or that trigger condition S should be removed from the set of trigger conditions that the system is monitoring.

The addition and/or removal of trigger condition may represent changes in the trigger condition that the system determines are more and/or less effective, given the present conditions and/or the change in conditions. The changes to the set of trigger conditions that are monitored may represent an increase and/or a decrease in the extent of monitoring that the system performs. The extent of monitoring may include the quantity of trigger condition that are monitored and/or a level of granularity of the monitoring. Additionally, or alternatively, the extent of monitoring may include an intensity of the monitoring. For example, low-intensity monitoring may include monitoring for an absence of one or more trigger events, such as an absence of potentially negative reports involving the student. High-intensity monitoring may include monitoring to confirm that trigger events have occurred, such as confirming that the student logged-in to a computing network for performing course work on a recurring basis.

In one example, the system generates updated academic interventions as conditions change over time. For example, as an academic performance prediction for a student changes from X, to Y, to Z over time, the system may modify the academic interventions that the system selects for the student. When the academic performance prediction for a student is X, the system may determine that academic interventions R and academic interventions S should be provided. When the academic performance prediction for the student changes from X to Y, the system may determine that academic interventions T should be added and/or that academic interventions R should be removed. When the academic performance prediction for the student changes from Y to Z, the system may determine that trigger condition U should be added and/or that trigger condition S should be removed. The addition and/or removal of academic interventions may represent changes in the academic interventions that the system determines are more and/or less effective, given the present conditions and/or the change in conditions. The changes to the set of academic interventions may represent an increase and/or a decrease in the extent of the academic interventions. The extent of the academic interventions may include the quantity of academic interventions that are provided and/or a frequency of the academic interventions. Additionally, or alternatively, the extent of the academic interventions may include an intensity of the academic interventions. For example, low-intensity academic interventions may include self-administered interventions, such as providing suggested areas for improvement via an API, scheduling a check-in meeting with an advisor and/or providing a meeting invention and/or reminder via the API. High-intensity academic interventions may include enrolling the student in a study group and/or providing a set of meeting invitations and/or reminders via the API. Another high-intensity academic intervention may include coordinating an accommodation for the student and providing information about the accommodation via the API.

### E. Generating Academic Intervention Workflows in Response to Trigger Events.

In one example, the system performs operations pertaining to generating academic intervention workflows in response to trigger events that satisfy trigger conditions. The system monitors a set of trigger conditions for initiating a set of academic intervention workflows for a set of students. The set of trigger conditions may include a subset of trigger conditions that are monitored for the set of students, for example, by default. Additionally, or alternatively, the set of trigger conditions may include, for a particular student, one or more trigger condition that are monitored specifically for the particular student. The one or more trigger condition that are monitored specifically for the particular student may be determined, for example, by a machine-learning model, based on the student information dataset, the academic performance prediction, and/or the academic intervention for the particular student.

The system determines whether a trigger event has occurred for initiating an academic intervention workflow. In one example, the system receives a notification of an occurrence of a trigger event. The notification of the occurrence of the trigger event may include a trigger condition identifier. The system may determine information about the one or more trigger conditions that are satisfied by the trigger event based on the trigger condition identifier.

In response to determining an occurrence of a trigger event, the system determines a student associated with the trigger event. One or more students may be associated with the trigger event. In one example, the data repository includes a mapping of trigger condition identifiers to one or more students that are associated with particular trigger events.

Upon having determined a student associated with the trigger event, the system determines one or more operations to perform in response to the trigger event. The one or more operations may be defined by a trigger condition that is satisfied by the trigger event. Additionally, or alternatively, the trigger condition may be mapped to one or operations to perform in response to a trigger event that satisfies the trigger condition. The one or more operations may include one or more operations associated with initiating execution of an academic intervention workflow associated with the student.

In one example, the data repository includes a mapping of trigger condition identifiers and/or students to one or more academic intervention workflows to initiate in response to trigger events that satisfy the trigger condition. The one or more academic intervention workflows to be initiated may depend on the particular trigger condition and/or the particular student. For example, in response to a trigger event that satisfies trigger condition X, the system may initiate academic intervention workflow A with respect to student Y and academic intervention workflow B with respect to student Z, where academic intervention workflow A and academic intervention workflow B are different from one another. Additionally, or alternatively, in response to a trigger event that satisfies trigger condition W, the system may initiate academic intervention workflow A with respect to student Z and academic intervention workflow D with respect to student Z, where trigger condition W and trigger condition X are different from one another. The system may perform the same action in response to different trigger events and/or in response to different trigger conditions that are satisfied by a trigger event. In the preceding example, the system initiates academic intervention workflow A with respect to student Y in response to a trigger event that satisfies trigger condition X and the system initiates academic intervention workflow A with respect to student Z in response to a trigger event that satisfies trigger condition W.

In one example, the system determines a set of one or more nodes of the system to transmit the academic intervention workflow. In one example, the data repository incudes a mapping of academic intervention workflows to recipients for transmitting a notification of the academic intervention workflow. The one or more recipients of the notification of the academic intervention workflow may depend on the particular academic intervention workflow. For example, the mapping may identify recipient A and/or recipient B to receive notification of academic intervention workflow X. Additionally, or alternatively, the mapping may identify recipient C and/or recipient D to receive notification of academic intervention workflow Y. In one example, an academic intervention workflow includes providing a notification of an academic intervention to one or more recipients. The notification may include an option to initiate the academic intervention, such as an option to sign up for tutoring and/or to schedule a time to meet with an academic professional such as an academic advisor, an instructor, or a teaching assistant. The recipients may include nodes associated with the system. Additionally, or alternatively, the nodes may include email addresses associated with students, advisors, faculty, tutors, or other entities associated with the system.

Upon having determined the set of one or more recipients, the system transmits the academic intervention workflow to the set of one or more nodes of the system. In one example, a workflow may include transmitting academic performance predictions, academic interventions, and/or trigger conditions to various nodes. Additionally, or alternatively, a workflow may include delivering academic interventions. Additionally, or alternatively, a workflow may include generating event objects for listening for trigger events and/or generating listening requests and transmit the listening requests to event handling agents.

In one example, the trigger event is associated with multiple students. For example, multiple students may be associated with a particular trigger event. The system determines whether there another student associated with the trigger event. When the system determines that another student is associated with the trigger event, the system generates an academic intervention workflow associated with the student in response to the trigger event.

### F. Retraining Machine-Learning Models.

In one example, the system performs operations pertaining to retraining machine-learning models. The system receives academic outcome data associated with an academic intervention for a student. The system may receive academic outcome data for multiple students. The academic outcome data may be stored in a data repository.

In response to receiving the academic outcome data, the system generates a retraining dataset that includes the academic outcome data. The retraining dataset may include the academic outcome data and at least one of the following: a set of inputs to one or more machine-learning models and/or a set of outputs of one or more machine-learning models. In one example, the retraining dataset includes, for multiple students, an academic outcome dataset for a particular student and a student information dataset for the particular student. Additionally, or alternatively, the academic outcome dataset for the particular student may be associated with one or more outputs of a machine-learning model that were generated based on the student information dataset for the particular student. For example, the academic outcome dataset for the particular student may be associated with an academic performance prediction for the particular student, an academic intervention for the particular student, and/or a set of one or more trigger conditions for updating at least one of the academic performance prediction or the academic intervention for the particular student.

The system may update the retraining dataset and/or generate additional retraining data sets when the system receives additional academic outcome data. The system determines whether additional academic outcome data is available. When the system determines that additional academic outcome data is available, the system updates the retraining dataset and/or generates an additional retraining data set.

Upon having generated a retraining dataset, the system retrains one or more machine-learning models based on the retraining dataset. In one example, the system retrains a machine-learning model to generate an academic performance prediction for a student based on a student information dataset pertaining to the student. In one example, the system retrains a machine-learning model to generate an academic intervention for a student based on at least one of the student information dataset or the academic performance prediction. In one example, the system retrains a machine-learning model to generate a set of one or more trigger conditions for performing operations associated with the system. The operations associated with the system may include updating academic performance predictions and/or academic interventions for students. Additionally, or alternatively, the operations associated with the system may include initiating a set of one or more academic intervention workflows with respect to the student.

### 6. EXAMPLE MACHINE-LEARNING SYSTEM

### A. Example Architecture of a Machine-Learning System.

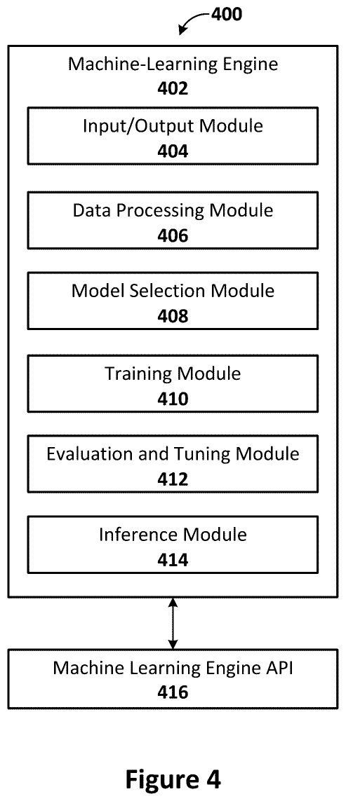

FIG. 4 illustrates an example architecture of a machine-learning system 400. The machine-learning system 400 includes a machine-learning engine 402 in accordance with one or more embodiments. As illustrated in FIG. 4, machine-learning engine 402 includes input/output module 404, data preprocessing module 406, model selection module 408, training module 410, evaluation and tuning module 412, and inference module 414.

In accordance with an embodiment, input/output module 404 serves as the primary interface for data entering and exiting the system, managing the flow and integrity of data. This module may accommodate a wide range of data sources and formats to facilitate integration and communication within the machine-learning architecture.

In an embodiment, an input handler within input/output module 404 includes a data ingestion framework capable of interfacing with various data sources, such as databases, A Pls, file systems, and real-time data streams. This framework is equipped with functionalities to handle different data formats (e.g., CSV, JSON, XML) and efficiently manage large volumes of data. It includes mechanisms for batch and real-time data processing that enable the input/output module 404 to be versatile in different operational contexts, whether processing historical datasets or streaming data.

In accordance with an embodiment, input/output module 404 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine-learning process.

In an embodiment, an output handler within input/output module 404 includes an output framework designed to handle the distribution and exportation of outputs, predictions, or insights. Using the output framework, input/output module 404 formats these outputs into user-friendly and accessible formats, such as reports, visualizations, or data files compatible with other systems. Input/output module 404 also ensures secure and efficient transmission of these outputs to end-users or other systems in an embodiment and may employ encryption and secure data transfer protocols to maintain data confidentiality.

In accordance with an embodiment, data preprocessing module 406 transforms data into a format suitable for use by other modules in machine-learning engine 402. For example, data preprocessing module 406 may transform raw data into a normalized or standardized format suitable for training ML models and for processing new data inputs for inference. In an embodiment, data preprocessing module 406 acts as a bridge between the raw data sources and the analytical capabilities of machine-learning engine 402.

In an embodiment, data preprocessing module 406 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 406 may be configured to handle anomalies in different ways depending on context. Data preprocessing module 406 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 406 includes a feature encoding framework that ensures categorical variables are transformed into a format that can be easily interpreted by machine-learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 406 processes new data for inference, data preprocessing module 406 replicates the same preprocessing steps to ensure consistency with the training data format. This helps to avoid discrepancies between the training data format and the inference data format, thereby reducing the likelihood of inaccurate or invalid model predictions.

In an embodiment, model selection module 408 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 408 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 408 utilizes techniques from the field of Automated Machine-learning (AutoML). AutoML systems automate the process of model selection by rapidly prototyping and evaluating multiple models. They use techniques like Bayesian optimization, genetic algorithms, or reinforcement learning to explore the model space efficiently. Model selection module 408 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 408 also considers computational efficiency and resource constraints. This is meant to help ensure the selected model is both accurate and practical in terms of computational and time requirements. In an embodiment, certain features of model selection module 408 are configurable such as a configured bias toward (or against) computational efficiency.

In accordance with an embodiment, training module 410 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 410 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 410 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 410 includes logic to handle different types of data and learning tasks. For instance, it includes different training routines for supervised learning (where the training data comes with labels) and unsupervised learning (without labeled data). In the case of deep learning models, training module 410 also manages the complexities of training neural networks that include initializing network weights, choosing activation functions, and setting up neural network layers.

In an embodiment, evaluation and tuning module 412 incorporates dynamic feedback mechanisms and facilitates continuous model evolution to help ensure the system's relevance and accuracy as the data landscape changes. Evaluation and tuning module 412 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 412 performs continuous model tuning by using hyperparameter optimization. Evaluation and tuning module 412 performs an exploration of the hyperparameter space using algorithms, such as grid search, random search, or more sophisticated methods like Bayesian optimization. Evaluation and tuning module 412 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 412 integrates data feedback and updates the model. Evaluation and tuning module 412 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 412 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 412 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 414 transforms data raw data into actionable, precise, and contextually relevant predictions. In addition to processing and applying a trained model to new data, inference module 414 may also include post-processing logic that refines the raw outputs of the model into meaningful insights.

In an embodiment, inference module 414 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 414 transforms the outputs of a trained model into definitive classifications. Inference module 414 employs the underlying model as a tool to generate probabilistic outputs for each potential class. It then engages in an interpretative process to convert these probabilities into concrete class labels.

In an embodiment, when inference module 414 receives the probabilistic outputs from the model, it analyzes these probabilities to determine how they are distributed across some or every potential class. If the highest probability is not significantly greater than the others, inference module 414 may determine that there is ambiguity or interpret this as a lack of confidence displayed by the model.

In an embodiment, inference module 414 uses thresholding techniques for applications where making a definitive decision based on the highest probability might not suffice due to the critical nature of the decision. In such cases, inference module 414 assesses if the highest probability surpasses a certain confidence threshold that is predetermined based on the specific requirements of the application. If the probabilities do not meet this threshold, inference module 414 may flag the result as uncertain or defer the decision to a human expert. Inference module 414 dynamically adjusts the decision thresholds based on the sensitivity and specificity requirements of the application, subject to calibration for balancing the trade-offs between false positives and false negatives.

In accordance with an embodiment, inference module 414 contextualizes the probability distribution against the backdrop of the specific application. This involves a comparative analysis, especially in instances where multiple classes have similar probability scores, to deduce the most plausible classification. In an embodiment, inference module 414 may incorporate additional decision-making rules or contextual information to guide this analysis, ensuring that the classification aligns with the practical and contextual nuances of the application.

In regression models, where the outputs are continuous values, inference module 414 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 414 incorporates domain-specific adjustments into its post-processing routine. This involves tailoring the model's output to align with specific industry knowledge or contextual information. For example, in financial forecasting, inference module 414 may adjust predictions based on current market trends, economic indicators, or recent significant events, ensuring that the outputs are both statistically accurate and practically relevant.

In an embodiment, inference module 414 includes logic to handle uncertainty and ambiguity in the model's predictions. In cases where inference module 414 outputs a measure of uncertainty, such as in Bayesian inference models, inference module 414 interprets these uncertainty measures by converting probabilistic distributions or confidence intervals into a format that can be easily understood and acted upon. This provides users with both a prediction and an insight into the confidence level of that prediction. In an embodiment, inference module 414 includes mechanisms for involving human oversight or integrating the instance into a feedback loop for subsequent analysis and model refinement.

In an embodiment, inference module 414 formats the final predictions for end-user consumption. Predictions are converted into visualizations, user-friendly reports, or interactive interfaces. In some systems, like recommendation engines, inference module 414 also integrates feedback mechanisms, where user responses to the predictions are used to continually refine and improve the model, creating a dynamic, self-improving system.

### B. Example Operations of a Machine-Learning System.

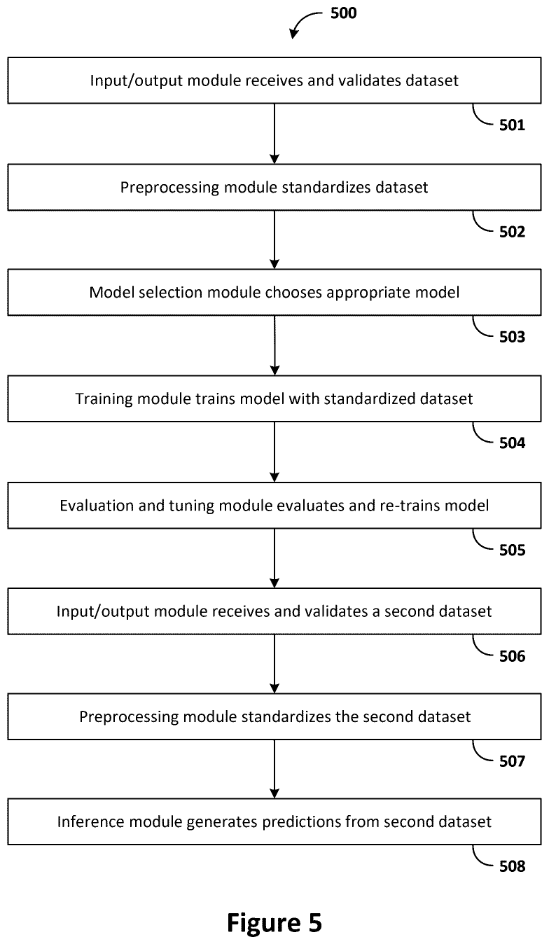

FIG. 5 illustrates example operations 500 of a machine-learning system in one or more embodiments. In an embodiment, input/output module 404 receives a dataset intended for training (Operation 501). This data can originate from diverse sources, like databases or real-time data streams, and in varied formats, such as CSV, JSON, or XML. Input/output module 404 assesses and validates the data, ensuring its integrity by checking for consistency, data ranges, and types.

In an embodiment, training data is passed to data preprocessing module 406. Here, the data undergoes a series of transformations to standardize and clean it, making it suitable for training ML models (Operation 502). This involves normalizing numerical data, encoding categorical variables, and handling missing values through techniques like imputation.

In an embodiment, prepared data from the data preprocessing module 406 is then fed into model selection module 408 (Operation 503). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 410 trains the selected model with the prepared dataset (Operation 504). It implements learning algorithms to adjust the model's internal parameters, optimizing them to identify patterns and relationships in the training data. Training module 410 also addresses the challenge of overfitting by implementing techniques, like regularization and early stopping, ensuring the model's generalizability.

In an embodiment, evaluation and tuning module 412 evaluates the trained model's performance using the validation dataset (Operation 505). Evaluation and tuning module 412 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 404 receives a dataset intended for inference. Input/output module 404 assesses and validates the data (Operation 506).

In an embodiment, data preprocessing module 406 receives the validated dataset intended for inference (Operation 507). Data preprocessing module 406 ensures that the data format used in training is replicated for the new inference data, maintaining consistency and accuracy for the model's predictions.

In an embodiment, inference module 414 processes the new data set intended for inference, using the trained and tuned model (Operation 508). It applies the model to this data, generating raw probabilistic outputs for predictions. Inference module 414 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, the machine-learning system 400 includes a machine-learning engine API 416. The machine-learning engine API 416 allows for applications to leverage machine-learning engine 402. In an embodiment, machine-learning engine API 416 may be built on a RESTful architecture and offer stateless interactions over standard HTTP/HTTPS protocols. Machine-learning engine API 416 may feature a variety of endpoints, each tailored to a specific function within machine-learning engine 402. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine-learning engine API 416 is equipped to support SOAP-based interactions. This extension involves defining a WSDL (Web Services Description Language) document that outlines the API's operations and the structure of request and response messages. In an embodiment, machine-learning engine API 416 supports various data formats and communication styles. In an embodiment, machine-learning engine API 416 endpoints may handle requests in J SON format or any other suitable format. For example, machine-learning engine API 416 may process XML, and it may also be engineered to handle more compact and efficient data formats, such as Protocol Buffers or Avro, for use in bandwidth-limited scenarios.

In an embodiment, machine-learning engine API 416 is designed to integrate WebSocket technology for applications necessitating real-time data processing and immediate feedback. This integration enables a continuous, bi-directional communication channel for a dynamic and interactive data exchange between the application and machine-learning engine 402.

### C. Example Generative Models of a Machine-Learning System.

A generative model is a machine-learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 404, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 406 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 408, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 410, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 412 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 414, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine-learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine-learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 7. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as HTTP. The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (Saas), Platform-as-a-Service (PaaS), and Infrastructure-as-a-Service (IaaS). In SaaS, a service provider provides end users the capability to use the service provider's applications, that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 8. MICROSERVICE APPLICATIONS

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, that are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 9. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICS, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

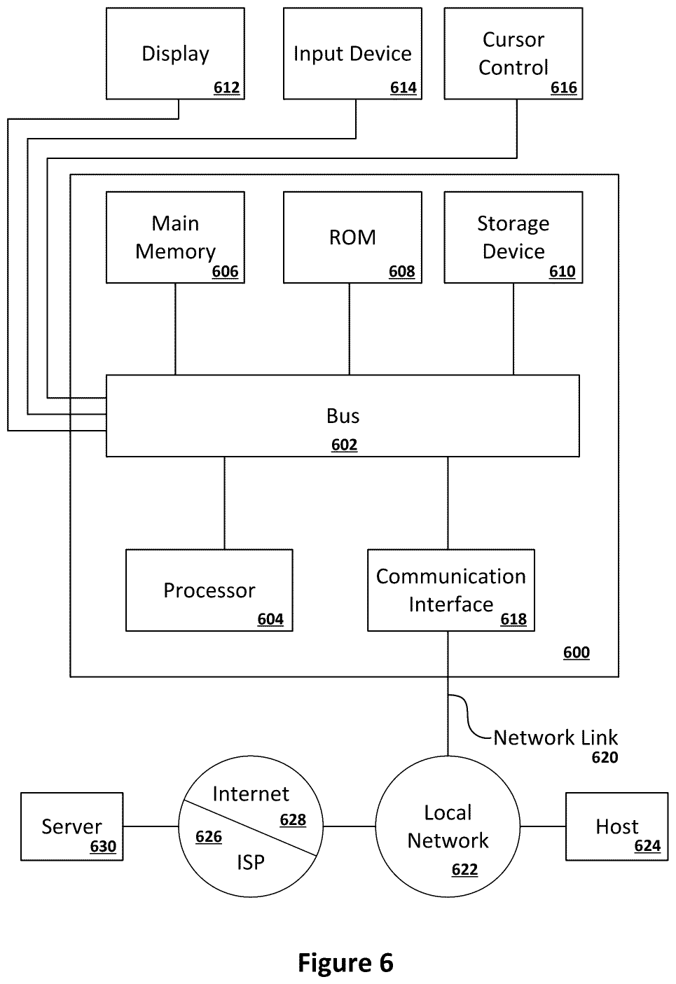

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid-State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic that in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, that carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 10. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner that might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media comprises instructions that, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method, comprising:
training a machine-learning model to predict a likelihood of a student making satisfactory academic progress (SAP) based on (a) data of a first type that describes historical academic results and (b) data of a second type that does not describe any kind of academic results;
determining that a first subset of a first set of data, exposed by a first computer system associated with an academic institution, is associated with a particular student enrolled at the academic institution;
monitoring, on an ongoing basis, a first application programming interface (API) of a second computer system that exposes a second set of data of the second type;
while monitoring the first API of the second computer system during a current academic period, detecting a first change in the second set of data exposed by the first API of the second computer system;
responsive to detecting the first change in the second set of data:
identifying, in the second set of data, a second subset of the second set of data that is associated with the particular student, and
applying the machine-learning model to the first subset of the first set of data and the second subset of the second set of data, to obtain a predicted likelihood of the particular student making SAP at the academic institution;
responsive to determining that the predicted likelihood of the particular student making SAP at the academic institution does not satisfy a threshold criterion: presenting, in a graphical user interface, a warning that the particular student is at risk of not making SAP.

2. The method of claim 1, wherein the first subset of the first set of data indicates that the particular student has not yet completed any academic period at the academic institution.

3. The method of claim 1, further comprising:
while monitoring the first API of the second computer system during the current academic period, detecting a second change in the second set of data;
responsive to detecting the second change in the second set of data:
identifying, in the second set of data, a third subset of the second set of data that is associated with the particular student, wherein the third subset of data reflects the second change in the second set of data;
reapplying the machine-learning model based on the third subset of the second set of data to obtain an updated predicted likelihood of the particular student making SAP.

4. The method of claim 1, further comprising:
after the current academic period has completed, detecting a second change in the first set of data;
retraining the machine-learning model based on the second change in the first set of data.

5. The method of claim 1, wherein monitoring the first API of the second computer system comprises:
querying the first API.

6. The method of claim 1, wherein monitoring the first API of the second computer system comprises:
supplying, to the first API, a uniform resource locator (URL) for receiving notifications of changes to the second set of data;
receiving, from the second computer system via the URL, the notifications of changes to the second set of data.

7. The method of claim 1, further comprising:
monitoring a second API of the first computer system to access the first set of data.

8. The method of claim 1, wherein the second set of data comprises data from one or more of a parking system, a dining hall system, a residence hall system, a campus security system, an electronic health records system, or a social media system.

9. One or more non-transitory computer-readable media comprising instructions that, when executed by one or more hardware processors, cause performance of operations comprising:
training a machine-learning model to predict a likelihood of a student making satisfactory academic progress (SAP) based on (a) data of a first type that describes historical academic results and (b) data of a second type that does not describe any kind of academic results;
determining that a first subset of a first set of data, exposed by a first computer system associated with an academic institution, is associated with a particular student enrolled at the academic institution;
monitoring, on an ongoing basis, a first application programming interface (API) of a second computer system that exposes a second set of data of the second type;
while monitoring the first API of the second computer system during a current academic period, detecting a first change in the second set of data exposed by the first API of the second computer system;
responsive to detecting the first change in the second set of data:
identifying, in the second set of data, a second subset of the second set of data that is associated with the particular student, and
applying the machine-learning model to the first subset of the first set of data and the second subset of the second set of data, to obtain a predicted likelihood of the particular student making SAP at the academic institution;
responsive to determining that the predicted likelihood of the particular student making SAP at the academic institution does not satisfy a threshold criterion: presenting, in a graphical user interface, a warning that the particular student is at risk of not making SAP.

10. The one or more media of claim 9, wherein the first subset of the first set of data indicates that the particular student has not yet completed any academic period at the academic institution.

11. The one or more media of claim 9, the operations further comprising:
while monitoring the first API of the second computer system during the current academic period, detecting a second change in the second set of data;
responsive to detecting the second change in the second set of data:
identifying, in the second set of data, a third subset of the second set of data that is associated with the particular student, wherein the third subset of data reflects the second change in the second set of data;
reapplying the machine-learning model based on the third subset of the second set of data to obtain an updated predicted likelihood of the particular student making SAP.

12. The one or more media of claim 9, the operations further comprising:
after the current academic period has completed, detecting a second change in the first set of data;
retraining the machine-learning model based on the second change in the first set of data.

13. The one or more media of claim 9, wherein monitoring the first API of the second computer system comprises:
querying the first API.

14. The one or more media of claim 9, wherein monitoring the first API of the second computer system comprises:
supplying, to the first API, a uniform resource locator (URL) for receiving notifications of changes to the second set of data;
receiving, from the second computer system via the URL, the notifications of changes to the second set of data.

15. The one or more media of claim 9, the operations further comprising:
monitoring a second API of the first computer system to access the first set of data.

16. The one or more media of claim 9, wherein the second set of data comprises data from one or more of a parking system, a dining hall system, a residence hall system, a campus security system, an electronic health records system, or a social media system.

17. A system comprising:
one or more hardware processors;
one or more non-transitory computer-readable media; and
program instructions stored on the one or more non-transitory computer-readable media that, when executed by the one or more hardware processors, cause the system to perform operations comprising:
training a machine-learning model to predict a likelihood of a student making satisfactory academic progress (SAP) based on (a) data of a first type that describes historical academic results and (b) data of a second type that does not describe any kind of academic results;
determining that a first subset of a first set of data, exposed by a first computer system associated with an academic institution, is associated with a particular student enrolled at the academic institution;
monitoring, on an ongoing basis, a first application programming interface (API) of a second computer system that exposes a second set of data of the second type;
while monitoring the first API of the second computer system during a current academic period, detecting a first change in the second set of data exposed by the first API of the second computer system;
responsive to detecting the first change in the second set of data:
identifying, in the second set of data, a second subset of the second set of data that is associated with the particular student, and
applying the machine-learning model to the first subset of the first set of data and the second subset of the second set of data, to obtain a predicted likelihood of the particular student making SAP at the academic institution;
responsive to determining that the predicted likelihood of the particular student making SAP at the academic institution does not satisfy a threshold criterion: presenting, in a graphical user interface, a warning that the particular student is at risk of not making SAP.

18. The system of claim 17, wherein the first subset of the first set of data indicates that the particular student has not yet completed any academic period at the academic institution.

19. The system of claim 17, further comprising:
while monitoring the first API of the second computer system during the current academic period, detecting a second change in the second set of data;
responsive to detecting the second change in the second set of data:
identifying, in the second set of data, a third subset of the second set of data that is associated with the particular student, wherein the third subset of data reflects the second change in the second set of data;
reapplying the machine-learning model based on the third subset of the second set of data to obtain an updated predicted likelihood of the particular student making SAP.

20. The system of claim 17, further comprising:
after the current academic period has completed, detecting a second change in the first set of data;
retraining the machine-learning model based on the second change in the first set of data.
